(19) United States
(12) Patent Application Publication
(10) Pub. No.: US 2005/0101508 A1
(43) Pub. Date: May 12, 2005

(54) Detergent components with tailored physical properties

(76) Inventors: Johannes Georg Winter, Strombeek-Bever (BE); Francesc Corominas, Bruxelles (BE); Maria Leonar Grandio Portabales, Bruxelles (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/964,155

(22) Filed: Oct. 13, 2004

(30) Foreign Application Priority Data
Oct. 15, 2003 (EP) 03 447 250.6
Nov. 5, 2003 (EP) 03 447 271.2

(51) Int. Cl. D06L 1/00; C11D 17/00

(52) U.S. Cl. 510/421

(57) ABSTRACT

The present invention relates to detergent components to be used in surfactant agglomerates, in a powder or tablet detergent compositions, comprising (a) a substituted or unsubstituted polyether; and (b) metal or half-metal, hard Lewis-acid having an effective ion radius of less than 100 pm. The present invention further relates to surfactant agglomerates, powder and tablet detergent compositions comprising such detergent component. The present invention also relates to processes for the preparation of such detergent components, surfactant agglomerates, powder and tablet detergent compositions.

### CROSS REFERENCE TO RELATED APPLICATION

This application claims priority under 35 U.S.C. § 119(e) to European Patent Office Serial No. 03447250.6, filed Oct. 15, 2003 and European Patent Office Serial No. 03447271.2, filed Nov. 5, 2003.

### FIELD OF THE INVENTION

The present invention relates to detergent components comprising a polyether and a hard Lewis acid. The present invention further relates to surfactant agglomerates, powder and tablet detergent compositions comprising such detergent component. The present invention also relates to processes for the preparation of such detergent components, surfactant agglomerates, powder and tablet detergent compositions.

### BACKGROUND TO THE INVENTION

Substituted or unsubstitued polyethers are common detergent ingredients. Non-limiting examples of such polyethers are nonionic alkoxylated surfactants and polyalkylene glycols. Nonionic alkoxylated surfactants are added into detergent compositions because they provide substantial cleaning performance. In particular, excellent cleaning performance is observed with nonionic surfactants having a low alkoxylation degree, e.g., between 1 to 50, preferably between 1 to 10. Such nonionic surfactants have additional advantages: reduced sensitivity against water hardness, better foam profile in aqueous solutions, good biodegradability, excellent cleaning even in cold water solutions, and particular effectiveness in removing mud, clays and oily stains. Thus, it is desired to include high levels of nonionic alkoxylated surfactants in detergent compositions.

Another representative from the group of substituted or unsubstituted polyethers are polyalkylene glycols, and in particular polyethylene glycols (PEG) and polypropylene glycols (PPG). Polyalkylene glycols are commonly used as binders in tablet detergent compositions. However, since polyalkylene glycols do not provide additional benefits than binding particles, it is desired to keep the level of polyalkylene glycols as low as possible in such formulations to provide room for other actives, while keeping the necessary binding property to particles.

WO 99/42206 (P&G, published Aug. 26, 1999), U.S. Pat. No. 4,648,987 (Clorox, published Mar. 10, 1987) and EP 971 028 (P&G, published Jan. 12, 2000) disclose a nonionic surfactant granule, comprising a nonionic alkoxylated surfactant, and a hydrotrope, selected from the group consisting of unsubstituted and substituted phenyl, benzyl, alkyl and alkenyl carboxylates, sulfonates and sulfates, and mixtures thereof.

JP-002 161 947 (Lion, published Oct. 31, 1995) discloses a tablet detergent composition comprising an anionic/alkoxylated nonionic surfactant mixture containing a dissolution promotor selected from potassium carbonate, ammonium sulfate, ammonium chloride, sodium benzoate, sodium benzene sulfonate, sodium p-toluene sulfonate, sodium xylene sulfonate, sodium chloride, citric acid, D-glucose, urea and sucrose.

U.S. Pat. No. 5,453,215 (UL, published Sep. 26, 1995), and EP 544 492 (Henkel, published Jun. 2, 1993) discloses detergent powders containing anionic and nonionic alkoxylated surfactants and alkali metal sulfates, carbonates, silicates, perborates, and fatty acid soaps.

U.S. Pat. No. 4,001,132 (P&G, published Jan. 4, 1977) describes a granular cleaning composition comprising an ethylene oxide/propylene oxide condensate of trimethylol propane, a sulfonated aromatic compatibilizing agent, such as potassium and/or sodium cumene sulfonate; and a water-soluble alkali metal sulfite, ammonium sulfite, alkali metal sulfate and/or ammonium sulfate.

EP 289 767 (Degussa, published Nov. 9, 1988) relates to a granular detergent composition containing an anionic/alkoxylated nonionic surfactant mixture and an absorption agent comprising sodium silicates and PEG.

WO 93/15180 (Henkel, Aug. 5, 1993) relates to granular detergent composition comprising an anionic/alkoxylated nonionic surfactant mixture and disintegrating agents selected from alkali metal salts and pseudo-alkali metals salts, such as sodium-, potassium- and ammonium-salts of organic amines, e.g., triethanol-based amines, and of sulfates, disulfates, sulfosuccinates and disulfosuccinates of PEG and polypropyleneglycols.

It is known in the art that polyethers should have certain physical properties to enable the formulator to incorporate them into detergent compositions according to their function. Examples are: melting point, viscosity, pumping behavior, temperature and storage stability, etc. In particular, the highly cleaning effective nonionic alkoxylated surfactants with a low alkoxylation degree tend to be difficult to be incorporated in detergent compositions, because of their low melting points of around 30° C. or even below room temperature. Another example are polyether binders: medium to high viscosity binders are better for effective binding but not easy to process on large scale since they require constant heating to be kept sprayable, and/or pumpable.

It is therefore an object of the present invention to provide a substituted or unsubstituted polyether with tailored physical properties for either enabling or at least facilitating the incorporation of such polyethers in solid detergent compositions: as surfactants at higher levels for improved cleaning, or as binders at lower level for effective binding.

It has been found that the incorporation of surfactants with low alkoxylation degree and binders with the low viscosity is possible when their melting points and/or viscosity profile is modified and/or tailored according to the specific requirements needed. Such modification has been achieved by combing polyethers with a hard Lewis acid. Such modified polyether can be incorporated in solid detergent compositions, e.g., in form of a modified nonionic surfactant into surfactant agglomerates, or in form of a binder into powder and tablet detergent compositions.

Without being bound by theory, it is believed that the interaction between the polyether and the hard Lewis acid affects the physical properties of such polyethers, such that the melting point and/or the viscosity is increased. We believe that the hard Lewis acid is interacting with the oxygen atom of the polyether (and/or potentially with more than one oxygen atom of either one polyether and/or with one or more oxygen atoms from more than one polyether) and thereby modifies the physical properties of the resulting composition, by limiting the flexibility for movements of such molecules.

In addition, it is often observed that powder detergent particles stick together for various reasons: increased humidity and/or temperature in the surrounding environment. Therefore, certain ingredients of the detergent particle melt, which increases their mobility within the particle so that they can move onto the particle surface. It has been found that sprayed on Lewis-acid modified polyethers with a high melting point prevent low melting components to move from the particle interior onto the particle surface so that caking is effectively reduced.

### SUMMARY OF THE INVENTION

The present invention relates to a detergent component to be used in a solid detergent composition, comprising:
(a) a substituted or unsubstituted polyether; and
(b) a metal or half-metal, hard Lewis-acid having an effective ion radius of less than 100 pm.

The present invention also relates to a surfactant agglomerate comprising a carrier and the detergent component of the present invention. In another embodiment, the present invention relates to a powder detergent composition on which the detergent component of the present invention is sprayed-on. The present invention further relates to tablet detergent compositions comprising particulate materials containing a detergent composition, and further comprising a binder between the particulate materials, wherein the binder comprises the detergent component of the present invention.

In still another embodiment of the present invention, there is provided the use of a metal or half-metal, hard Lewis acid for increasing the viscosity and/or melting point of a unsubstituted or substituted polyether.

The present application is also directed to processes for making a surfactant agglomerate, a powder detergent composition and a tablet detergent composition.

### DETAILED DESCRIPTION OF THE INVENTION

As used herein, the term “substituted” means: substituted by any suitable substituent, such as fluoride, chloride, bromide, iodide, C₁-C₁₆ branched or linear hydrocarbon, and/or hydroxy, preferably C₁-C₄ alkyl and/or hydroxy.

As used herein, the term “solid detergent composition” means: a solid detergent composition in form of an agglomerate, in form of a powder detergent composition, and/or in form of a tablet detergent composition.

As used herein, the term “melting point” means also softening point, melting range and/or softening range, since many of the compounds, ingredients and components of the present invention don't have a sharp melting point but instead, they melt or soften within a certain temperature window.

The Detergent Component:

1. Substituted or Unsubstitued Polyethers

The detergent component of the present invention comprise a substituted or unsubstituted polyether, at levels from 1% to 99%, preferably from 10% to 95%, more preferably from 20% to 90%, and most preferably from 30% to 80%, by weight of the detergent component.

Generally, any substituted or unsubstituted polyether can be used for incorporation into the detergent components of the present invention. Typically, such polyethers are alkoxylated with groups selected from ethoxy-(—CH₂CH₂O—) groups, n-propoxy-(—CH₂CH₂CH₂O—) groups, iso-propoxy-(—CH₂CH(CH₃)O—) groups, n-butoxy-(—CH₂CH₂CH₂CH₂O—) groups, iso-butoxy-(—CH₂CH(CH₃)CH₂O—) groups, tert-butoxy-(—CH₂C(CH₃)₂O—) groups, and any combination thereof.

The alkoxylation degree of such a polyether can generally have any value. Typically, the alkoxylation degree of such polyether is from 2 to 500, preferably from 3 to 100, more preferably from 4 to 35, and most preferably from 5 to 15.

Some polyethers are particularly preferred for incorporation into the detergent component of the present invention, as stated below. In general, substituted or unsubstituted polyether can be selected from the group of nonionic alkoxylated surfactants or nonionic binders:

a. Nonionic Alkoxylated Surfactants

Typically any nonionic alkoxylated surfactant useful for detersive purposes that is liquid below 80° C., preferably below 60° C., more preferably below 45° C. can be included in the detergent component of the present invention. Preferred nonionic surfactants for use herein are described in more detail hereinafter. More commonly used for the purpose of the present invention are the alkylpolyethoxylates, like the commercially available Neodol® 23-AE 5, Neodol® 45-AE 5, Neodol® 45-AE 7, Lialet® 125-AE 3, Lialet® 123-AE 3, Lialet® 123-AE 5, Lialet® 125-AE 5.

Suitable nonionic surfactants for the purpose of the present invention are described below:

### Nonionic Non-End Capped Ethoxylated Alcohol Surfactant

The alkyl ethoxylate condensation products of aliphatic alcohols with from 1 to 25 moles of ethylene oxide are suitable for use herein. The alkyl chain of the aliphatic alcohol can either be straight or branched, primary or secondary, and generally contains from 6 to 22 carbon atoms, preferably from 12 to 17 carbon atoms, even more preferably from 14 to 15 carbon atoms. Particularly preferred are the condensation products of alcohols having an alkyl group containing from 12 to 17 carbon atoms, preferably from 14 to 15 carbon atoms, with from 2 to 500, more preferably from 3 to 100, even more preferably from 4 to 35, and most preferably with from 5 to 15 moles of ethylene oxide per mole of alcohol.

### End-Capped Alkyl Alkoxylate Surfactant

A suitable nonionic surfactant for use herein is an endcapped alkyl alkoxylate surfactant, preferred is the epoxy-capped poly(oxyalkylated) alcohols represented by the formula:
R¹O[CH₂CH(CH₃)O]ₓ[CH₂CH₂O]_{y}[CH₂CH(OH)R²] (I)
wherein R¹O is an epoxy group wherein, R¹ is a linear or branched, aliphatic hydrocarbon radical having from 4 to 18 carbon atoms; R² is a linear or branched aliphatic hydrocarbon radical having from 2 to 26 carbon atoms; x is an integer having an average value of from 0 to 2, more preferably 1; and y is an integer having a value of at least 2 more preferably at least 5, even more preferably at least 10, and most preferably at least 20.

Preferably, the nonionic surfactant of formula I, comprises at least 10 carbon atoms in the terminal epoxide unit [CH₂CH(OH)R²]. Suitable nonionic surfactants of formula I, for use herein, are Olin Corporation's POLY-TERGENT® SLF-18B nonionic surfactants, as described, for example, in WO 94/22800, published Oct. 13, 1994 by Olin Corporation.

### Ether-Capped poly(oxyalkylated) Alcohols

Preferred nonionic surfactants for use herein, include ether-capped poly(oxyalkylated) alcohols having the formula:
R¹O[CH₂CH(R³)O]ₓ[CH₂]ₖCH(OH)[CH₂]ⱼOR²
wherein R¹ and R² are linear or branched, saturated or unsaturated, aliphatic or aromatic hydrocarbon radicals having from 1 to 30 carbon atoms; R³ is H, or a linear aliphatic hydrocarbon radical having from 1 to 4 carbon atoms; x is an integer having an average value from 1 to 12, wherein when x is 2 or greater, R³ may be the same or different and k and j are integers having an average value of from 1 to 12, and more preferably 1 to 5.

R¹ and R² are preferably linear or branched, saturated or unsaturated, aliphatic or aromatic hydrocarbon radicals having from 6 to 22 carbon atoms with 8 to 18 carbon atoms being most preferred. H or a linear aliphatic hydrocarbon radical having from 1 to 2 carbon atoms is most preferred for R³. Preferably, x is an integer having an average value of from 1 to 9, more preferably from 3 to 7.

As described above, when x is greater than 2, R³ may be the same or different. That is, R³ may vary between any of the alkyleneoxy units as described above. For instance, if x is 3, R³ may be selected to form ethyleneoxy(EO) or propyleneoxy(PO) and may vary in order of (EO)(PO)(EO), (EO)(EO)(PO); (EO)(EO)(EO); (PO)(EO)(PO); (PO)(PO)(EO) and (PO)(PO)(PO). Of course, the integer three is chosen for example only and the variation may be much larger with a higher integer value for x and include, for example, multiple (EO) units and a much small number of (PO) units.

Most preferred ether-capped poly(oxyalkylated) alcohol surfactants are those wherein k is 1 and j is 1 so that the surfactants have the formula:
R¹O[CH₂CH(R³)O]ₓCH₂CH(OH)CH₂OR²
where R¹, R² and R³ are defined as above and x is an integer with an average value of from 1 to 12, preferably from 1 to 9, and even more preferably from 3 to 7. Most preferred are surfactants wherein R¹ and R² range from 9 to 14, R³ is H forming ethyleneoxy and x ranges from 1 to 9.

The ether-capped poly(oxyalkylated) alcohol surfactants comprise three general components, namely a linear or branched alcohol, an alkylene oxide and an alkyl ether end cap. The alkyl ether end cap and the alcohol serve as a hydrophobic, oil-soluble portion of the molecule while the alkylene oxide group forms the hydrophilic, water-soluble portion of the molecule.

Generally speaking, the ether-capped poly(oxyalkylene) alcohol surfactants suitable for use herein may be produced by reacting an aliphatic alcohol with an epoxide to form an ether which is then reacted with a base to form a second epoxide. The second epoxide is then reacted with an alkoxylated alcohol.

### Nonionic Ethoxylated/Propoxylated Fatty Alcohol Surfactant

The ethoxylated C₆-C₁₈ fatty alcohols and C₆-C₁₈ mixed ethoxylated/propoxylated fatty alcohols are suitable surfactants for use herein, particularly where water-soluble. Preferably the ethoxylated fatty alcohols are the C₁₀-C₁₈ ethoxylated fatty alcohols with a degree of ethoxylation of from 1 to 12, most preferably these are the C₁₂-C₁₈ ethoxylated fatty alcohols with a degree of ethoxylation from 1 to 9. Preferably the mixed ethoxylated/propoxylated fatty alcohols have an alkyl chain length of from 10 to 18 carbon atoms, a degree of ethoxylation of from 3 to 9 and a degree of propoxylation of from 1 to 10.

b. Nonionic Binders

Suitable binders for the present invention are selected from the group consisting of polyalkylene glycols, polyalkylene glycol esters, fatty alcohol alkoxylates, polyglycol ethoxylated/propoxylated copolymers and/or mixtures thereof.

Preferred binders are selected from the group consisting of polyethylene glycols, and polyglycol ethoxylated/propoxylated copolymers and mixtures thereof. More preferred binders are polyethylene glycols having a molecular weight between 2,500 and 10,000. Most preferred binders are polyethylene glycols having a molecular weight between 3,500 and 7,000.

2. Hard Lewis Acid

The second essential element of the detergent component of the present invention is a metal or half-metal, hard Lewis acid having an effective ion radius of less than 100 pm (herein referred to as “hard Lewis acid”). Such Lewis acid is present at levels from 1.0% to 50%, preferably from 1.5% to 20%, more preferably from 2.0% to 10%, and most preferably from 2.5% to 5.0%, by weight of the detergent component.

As commonly understood by persons skilled in the art, the terms “metal” and “half-metal” refers to conductivity of the elements of the periodic table as disclosed for example in A. F. Holleman and E. Wiberg, Lehrbuch der Anorganische Chemie, de Gruyter, 1985, p. 301 to 302, and p. 731 to 734. Typically, Lithium (Li), Aluminium (Al) and Iron (Fe) for example are considered as metals, whereas Silicon (Si) for example is a typical example for a half-metal.

As commonly understood by persons skilled in the art, the term “hard” refers to the concept of “hard and soft acids and bases” as suggest by R. G. Pearson in J. Am. Chem. Soc. 85, 3533, 1963 and in subsequent publications such as: J. Chem. Educ. 45, 581, 643, 1968; Surv. Prog Chem. 1, 1, 1969; J. Am. Chem. Soc. 89, 1827, 1967 and “Hard and Soft Acids and Bases Principle in Organic Chemistry”, Academic Press, New York, 1977. The term “hard” means that the cationic charge of a Lewis acid is located on a small cationic species or on species having a positive formal oxidation state, wherein the cationic species has either only empty, half empty, or full electron orbitals. An example of a hard Lewis acid is B³⁺, having the electron configuration: 1s², 2s², 3s⁰, 3p⁰; the corresponding Boron atom has the electron configuration: 1s², 2s², 3s², 3p¹. In this context, it is mentioned that the cationic charge of the Lewis acids discloses herein reflects very often the formal oxidation state of the Lewis acid in a specific Lewis acidic material.

A compilation of effective ion radii can be found in James E. Huheey, Anorganische Chemie, de Gruyter, 1988, p. 78 to 81. Those effective ion radii were obtained according to a method as published by R. D. Shannon in Acta Crystallogr. A32, 751, 1976.

The following metal, half-metal hard Lewis-acids with an effective ion radius of less than 100 pm are encompassed in the present invention:

| | Coordination | |
|---|---|---|
| Ion | number | Radius in pm |
| Al³⁺ | 4 | 53 |
| Al³⁺ | 5 | 62 |
| Al³⁺ | 6 | 67.5 |
| B³⁺ | 3 | 15 |
| B³⁺ | 4 | 25 |
| B³⁺ | 6 | 41 |
| Be²⁺ | 3 | 30 |
| Be²⁺ | 4 | 41 |
| Be²⁺ | 6 | 59 |
| Co²⁺ | 6 ls (2) | 68.5 |
| Co²⁺ | 6 hs (1) | 88.5 |
| Cu²⁺ | 4 | 71 |
| Cu²⁺ | 5 | 79 |
| Cu²⁺ | 6 | 87 |
| Fe³⁺ | 4 hs (1) | 63 |
| Fe³⁺ | 5 | 72 |
| Fe³⁺ | 6 ls (2) | 69 |
| Fe³⁺ | 6 hs (1) | 78.5 |
| Fe³⁺ | 8 hs (1) | 92 |
| Ga³⁺ | 4 | 61 |
| Ga³⁺ | 5 | 69 |
| Ga³⁺ | 6 | 76 |
| Ge²⁺ | 6 | 87 |
| Ge⁴⁺ | 4 | 53 |
| Ge⁴⁺ | 6 | 67 |
| In³⁺ | 4 | 76 |
| In³⁺ | 6 | 94 |
| Li⁺ | 4 | 73 |
| Li⁺ | 6 | 90 |
| Mg²⁺ | 4 | 71 |
| Mg²⁺ | 5 | 80 |
| Mg²⁺ | 6 | 86 |
| Mn²⁺ | 4 hs | 80 |
| Mn²⁺ | 5 hs | 89 |
| Mn²⁺ | 6 ls | 81 |
| Mn²⁺ | 6 hs | 97 |
| Mn⁷⁺ | 4 | 39 |
| Mn⁷⁺ | 6 | 60 |
| Mo⁶⁺ | 4 | 55 |
| Mo⁶⁺ | 5 | 64 |
| Mo⁶⁺ | 6 | 73 |
| Mo⁶⁺ | 7 | 87 |
| Sc³⁺ | 6 | 88.5 |
| Si⁴⁺ | 4 | 40 |
| Si⁴⁺ | 6 | 54 |
| Sn⁴⁺ | 4 | 69 |
| Sn⁴⁺ | 5 | 76 |
| Sn⁴⁺ | 6 | 83 |
| Sn⁴⁺ | 7 | 89 |
| Sn⁴⁺ | 8 | 95 |
| Ti⁴⁺ | 4 | 56 |
| Ti⁴⁺ | 5 | 65 |
| Ti⁴⁺ | 6 | 74.5 |
| Ti⁴⁺ | 8 | 88 |
| Zn²⁺ | 4 | 74 |
| Zn²⁺ | 5 | 82 |
| Zn²⁺ | 6 | 88 |
| Zr⁴⁺ | 4 | 73 |
| Zr⁴⁺ | 5 | 80 |
| Zr⁴⁺ | 6 | 86 |
| Zr⁴⁺ | 7 | 92 |
| Zr⁴⁺ | 8 | 98 |

(1): high spin
(2): low spin
(3): square planar

Preferably, the hard Lewis-acids have an effective ion radius of less than 75 pm, more preferably of less than 55 pm.

Some hard Lewis-acids are less preferred because of potential side reactions such as oxidation, reduction, toxicity and other reactions which can make the Lewis acid potentially incompatible with other, sometimes just optional, ingredients of the detergent component and/or detergent compositions of the present invention. Thus, Be²⁺, Mn⁷⁺, and Mo⁶⁺ are less preferred. On the other hand, Al³⁺, B³⁺, Li⁺, and/or Mg²⁺ are preferred Lewis acids due to their low-toxicity profile.

Preferred Lewis acids for the present invention are: Al³⁺, B³⁺, Co²⁺ (4 hs, 6 ls), Cu²⁺ (4), Fe³⁺ (4 hs, 5, 6 ls), Ga³⁺ (4, 5), Ge⁴⁺, Li⁺ (4), Mg²⁺ (4), Si⁴⁺, Sn⁴⁺ (4), Ti⁴⁺ (4, 5, 6), Zn²⁺ (4), Zr⁴⁺ (4), and combinations thereof.

More preferred Lewis acids for the present invention are: Al³⁺(4), B³⁺, Ge⁴⁺ (4), Si⁴⁺, and combinations thereof.

The hard Lewis acid may be in neutral form or in form of a salt of the above cited species. In general, any salt of such hard Lewis acids may be used, such as the respective chloride, bromide, iodide, sulfate, sulfite, hydroxide, or methylsulfate salt, and mixtures thereof. However, particular advantageously are salts in which the compensating anion has a low charge density, e.g., a low charge of “−1”, or “−2”, or “−3”, or “4”, or “−5”, or “−6” etc., wherein the charge is delocalised over a large surface, e.g., big anions are preferred over small ions. In other words, iodine is preferred over bromide, bromide is preferred over chloride. Particularly preferred are anions from the following, non-limiting list: hexafluorosilicate (SiF₆²⁻), sulfite (SO₃²⁻), hydrogensulfite (HSO₃⁻), organosulfite (RSO₃²⁻), sulfate (SO₄²⁻), hydrogensulfate (HSO₄⁻), organosulfate (RSO₄⁻), phosphate (PO₄³⁻), hydrogenphosphate (HPO₄²⁻), dihydrogenphosphate (H₂PO₄⁻), tetrafluoro borate (BF₄⁻), tetrachloro borate (BCl₄⁻), tetrabromo borate (BBr₄⁻), tetraiodo borate (BI₄⁻), tetraphenyl borate (B[C₆H₅]₄⁻), tetra(pentafluoro)phenyl borate (B[C₆F₅]₄⁻), hexafluorophosphate (PF₆⁻), hexachloro aluminate (AlCl₆³⁻), hexabromo aluminate (AlBr₆³⁻), corresponding anion of an organic acid (OC[O]R⁻), wherein R is selected from the group of C₁ to C₃₀ substituted and unsubstituted, linear, branched, cyclic alkyl, alkenyl, aryl, alkylaryl, arylalkyl, alkenylaryl, arylalkenyl; and combinations thereof.

Suitable hard Lewis acids to be incorporated into the compositions of the present invention are:

AlCl₃, AlBr₃, AlI₃, Al₂(SiF₆)₃, Al₂(SO₃)₃, Al(HSO₃)₃, Al(SO₃R)₃, Al₂(SO₄)₃, Al(HSO₄)₃, Al(SO₄R)₃, AlPO₄, Al₂(HPO₄)₃, Al(H₂PO₄)₃, Al(BF₄)₃, Al(BCl₄)₃, Al(BBr₄)₃, Al(BI₄)₃, Al(B[C₆H₅]₄)₃, Al(B[C₆F₅]₄)₃, Al(PF₆)₃, Al(OH)₃, Al(OC[O]R)₃; BCl₃, BBr₃, BI₃, B₂(SiF₆)₃, B₂(SO₃)₃, B(HSO₃)₃, B(SO₃R)₃, B₂(SO₄)₃, B(HSO₄)₃, B(SO₄R)₃, B₂(HPO₄)₃, B(H₂PO₄)₃, B(BF₄)₃, B(BCl₄)₃, B(BBr₄)₃, B(BI₄)₃, B(B[C₆H₅]₄)₃, B(B[C₆F₅]₄)₃, B(PF₆)₃, B(AlCl₆), B(AlBr₆), B(OH)₃, B(OH)ₓ(OR)₃₋ₓ, B(OC[O]R)₃; BeCI₂, BeBr₂, BeI₂, Be(SiF₆), BeSO₃, Be(HSO₃)₂, Be(SO₃R)₂, BeSO₄, Be(HSO₄)₂, Be(SO₄R)₂, Be₃(PO₄)₂, BeHPO₄, Be(H₂PO₄)₂, Be(BF₄)₂, Be(BCl₄)₂, Be(BBr₄)₂, Be(BI₄)₂, Be(B[C₆H₅]₄)₂, Be(B[C₆F₅]₄)₂, Be(PF₆)₂, Be₃(AlCl₆)₂, Be₃(AlBr₆)₂, Be(OH)₂, Be(OC[O]R)₂; CuCl₂, CuBr₂, CuI₂, Cu(SiF₆), CuSO₃, Cu(HSO₃)₂, Cu(SO₃R)₂, CuSO₄, Cu(HSO₄)₂, Cu(SO₄R)₂, Cu₃(PO₄)₂, CuHPO₄, Cu(H₂PO₄)₂, Cu(BF₄)₂, Cu(BCl₄)₂, CU(BBr₄)₂, Cu(BI₄)₂, Cu(B[C₆H₅]₄)₂, Cu(B[C₆F₅]₄)₂, Cu(PF₆)₂, Cu₃(AlCl₆)₂, Cu₃(AlBr₆)₂, Cu(OH)₂, Cu(OC[O]R)₂; CoCl₂, CoBr₂, CoI₂, Co(SiF₆), CoSO₃, Co(HSO₃)₂, Co(SO₃R)₂, CoSO₄, Co(HSO₄)₂, Co(SO₄R)₂, CO₃(PO₄)₂, CoHPO₄, Co(H₂PO₄)₂, Co(BF₄)₂, Co(BCl₄)₂, Co(BBr₄)₂, Co(BI₄)₂, Co(B[C₆H₅]₄)₂, Co(B[C₆F₅]₄)₂, Co(PF₆)₂, CO₃(AlCl₆)₂, Co₃(AlBr₆)₂, Co(OH)₂, Co(OC[O]R)₂; FeCl₃, FeBr₃, FeI₃, Fe₂(SiF₆)₃, Fe₂(SO₃)₃, Fe(HSO₃)₃, Fe(SO₃R)₃, Fe₃(SO₄)₂, Fe(HSO₄)₃, Fe(SO₄R)₃, FePO₄, Fe₂(HPO₄)₃, Fe(H₂PO₄)₃, Fe(BF₄)₃, Fe(BCl₄)₃, Fe(BBr₄)₃, Fe(BI₄)₃, Fe(B[C₆H₅]₄)₃, Fe(B[C₆F₅]₄)₃, Fe(PF₆)₃, Fe(AlCl₆), Fe(AlBr₆), Fe(OH)₃, Fe(OC[O]R)₃; MgCl₂, MgBr₂, MgI₂, Mg(SiF₆), MgSO₃, Mg(HSO₃)₂, Mg(SO₃R)₂, MgSO₄, Mg(HSO₄)₂, Mg(SO₄R)₂, Mg₃(PO₄)₂, MgHPO₄, Mg(H₂PO₄)₂, Mg(BF₄)₂, Mg(BCl₄)₂, Mg(BBr₄)₂, Mg(BI₄)₂, Mg(B[C₆H₅]₄)₂, Mg(B[C₆F₅]₄)₂, Mg(PF₆)₂, Mg₃(AlCl₆)₂, Mg₃(AlBr₆)₂, Mg(OH)₂, Mg(OC[O]R)₂; MnCl₂, MnBr₂, MnI2, Mn(SiF₆), MnSO₃, Mn(HSO₃)₂, Mn(SO₃R)₂, MnSO₄, Mn(HSO₄)₂, Mn(SO₄R)₂, Mn₃(PO₄)₂, MnHPO₄, Mn(H₂PO₄)₂, Mn(BF₄)₂, Mn(BCl₄)₂, Mn(BBr₄)₂, Mn(BI₄)₂, Mn(B[C₆H₅]₄)₂, Mn(B[C₆F₅]₄)₂, Mn(PF₆)₂, Mn₃(AlCl₆)₂, Mn₃(AlBr₆)₂, Mn(OH)₂, Mn(OC[O]R)₂; TiCl₄, TiBr₄, TiI₄, Ti(SiF₆)₂, Ti(SO₃)₂, Ti(HSO₃)₄, Ti(SO₃R)₄, Ti(SO₄)₂, Ti(HSO₄)₄, Ti(SO₄R)₄, Ti₃(PO₄)₄, Ti(HPO₄)₂, Ti(H₂PO₄)₄, Ti(BF₄)₄, Ti(BCl₄)₄, Ti(BBr₄)₄, Ti(BI₄)₄, Ti(B[C₆H₅]₄)₄, Ti(B[C₆F₅]₄)₄, Ti(PF₆)₄, Ti₃(A Cl₆)₄, Ti₃(AlBr₆)₄, Ti(OH)₄, Ti(OC[O]R)₄; GaCl₃, GaBr₃, GaI3, Ga₂(SiF₆)₃, Ga₂(SO₃)₃, Ga(HSO₃)₃, Ga(SO₃R)₃, Ga₂(SO₄)₃, Ga(HSO₄)₃, Ga(SO₄R)₃, GaPO₄, Ga₂(HPO₄)₃, Ga(H₂PO₄)₃, Ga(BF₄)₃, Ga(BCl₄)₃, Ga(BBr₄)₃, Ga(BI₄)₃, Ga(B[C₆H₅]₄)₃, Ga(B[C₆F₅]₄)₃, Ga(PF₆)₃, Ga(AlCl₆), Ga(AlBr₆), Ga(OH)₃, Ga(OC[O]R)₃; InCl₃, InBr₃, InI₃, In₂(SiF₆)₃, In₂(SO₃)₃, In(HSO₃)₃, In(SO₃R)₃, In₂(SO₄)₃, In(HSO₄)₃, In(SO₄R)₃, InPO₄, In₂(HPO₄)₃, In(H₂PO₄)₃, In(BF₄)₃, In(BCl₄)₃, In(BBr₄)₃, In(BI₄)₃, In(B[C₆H₅]₄)₃, In(B[C₆F₅]₄)₃, In(PF₆)₃, In(AlCl₆), In(AlBr₆), In(OH)₃, In(OC[O]R)₃; LiCl, LiBr, LiI, Li₂(SiF₆), Li₂SO₃, LiHSO₃, Li(SO₃R), Li₂SO₄, LiHSO₄, Li(SO₄R), Li₃PO₄, Li₂HPO₄, LiH₂PO₄, LiBF₄, LiBCl₄, LiBBr₄, LiBI₄, Li(B[C₆H₅]₄), Li(B[C₆F₅]₄), LiPF₆, Li₃(AlCl₆), Li₃(AlBr₆), LiOH, Li(OC[O]R); and combinations thereof, wherein R is selected from the group of C₁ to C₃₀ substituted and unsubstituted, linear, branched, cyclic alkyl, alkenyl, aryl, alkylaryl, arylalkyl, alkenylaryl, arylalkenyl, and combinations thereof, and wherein x is an integer from 1 to 3.

Preferred Lewis acids for incorporation into the compositions of the present invention are selected from: AlBr₃, Al₂(SO₃)₃, Al(HSO₃)₃, Al₂(SO₄)₃, Al(HSO₄)₃, Al(SO₄R)₃, AlPO₄, Al₂(HPO₄)₃, Al(H₂PO₄)₃, Al(B[C₆H₅]₄)₃, Al(OH)₃, Al(OC[O]R)₃; BBr₃, BI₃, B₂(SO₃)₃, B(HSO₃)₃, B₂(SO₄)₃, B(HSO₄)₃, B(SO₄R)₃, B₂(HPO₄)₃, B(H₂PO₄)₃, B(B[C₆H₅]₄)₃, B(OH)₃, B(OH)ₓ(OR)₃₋ₓ, B(OC[O]R)₃; MgCl₂, MgBr₂, MgI₂, MgSO₃, Mg(HSO₃)₂, MgSO₄, Mg(HSO₄)₂, Mg(SO₄R)₂, Mg₃(PO₄)₂, MgHPO₄, Mg(H₂PO₄)₂, Mg(OH)₂, Mg(OC[O]R)₂; LiCl, LiBr, LiI, Li₂SO₃, LiHSO₃, Li(SO₃R), Li₂SO₄, LiHSO₄, Li(SO₄R), Li₃PO₄, Li₂HPO₄, LiH₂PO₄, LiOH, Li(OC[O]R); and combinations thereof, wherein R is selected from the group consisting of C₁ to C₁₅ unsubstituted and substituted, linear, branched or cyclic alkyl, and arylalkyl, such as CH₃, C₂H₅, CCl₃, CF₃, C₆H₄CH₃, C₆H₄C₂H₅, C₆H₄C₃H₇, C₆H₄C₄H₉, and combinations thereof, and wherein x is an integer from 1 to 3.

Concerning C₆H₄CH₃, C₆H₄C₂H₅, C₆H₄C₃H₇, C₆H₄C₄H₉, the respective ortho-, meta-, and para-derivatives are explicitly included herein.

More preferred hard Lewis acids for incorporation into the compositions of the present invention are selected from: Al₂(SO₄)₃, Al(SO₄R)₃, AlPO₄, Al₂(HPO₄)₃, Al(H₂PO₄)₃, Al(OH)₃, Al(OC[O]R)₃; B₂(SO₄)₃, B(SO₄R)₃, B₂(HPO₄)₃, B(H₂PO₄)₃, B(OH)₃, B(OH)X(OR)₃₋ₓ, B(OC[O]R)₃; and combinations thereof, wherein R is selected from the group consisting of C₁ to C₁₅ unsubstituted and substituted, linear, branched or cyclic alkyl, and arylalkyl, such as CH₃, C₂H₅, CCl₃, CF₃, C₆H₄CH₃, C₆H₄C₂H₅, C₆H₄C₃H₇, C₆H₄C₄H₉, and combinations thereof, and wherein x is an integer from 1 to 3.

3. Optional Ingredients of the Deterrent Component:

The detergent component of the present invention can further contain further ingredients as disclosed below.

The detergent component of the present invention may be used as nonionic surfactant in a surfactant agglomerate, as a spray-on on powder detergent compositions and as a binder in a tablet detergent composition.

The Surfactant Agglomerate

The present invention is also directed to a surfactant agglomerate comprising the detergent component of the present invention and a carrier. The detergent component may be incorporated typically at a level of from 0.1% to 80%, preferably from 5.0% to 50%, and more preferably from 10% to 35% by weight of the surfactant agglomerate.

Suitable carriers are powders and include zeolithes, bentonite clays, carbonates, silicas, silicates, sulphates, phosphates, citrates, citric acid and combinations thereof, as disclosed in EP 0 971 023 A1 in [0018]; and [0022] to [0025].

Said surfactant agglomerate can comprise further ingredients. Suitable further ingredients include: anionic, cationic, ampholytic, zwitterionic and semi-polar surfactants as disclosed in EP 0 971 023 A1 in [0015] to [0017]; water-soluble salts of acetate as disclosed in EP 0 971 023 A1 in [0019] to [0021]; water-soluble cationic compounds as disclosed in EP 0 971 023 A1 in [0026] to [0044]; cationic polymers as disclosed in EP 0 971 023 A1 in [0045] to [0059]; polyurethanes, polyesters, polyethers, polyamides or like polymers as disclosed in EP 0 971 023 A1 in [0060] to [0062] and [0077] to [0084]; polyacrylates, polyacrylamides, polyvinylether or the like polymers as disclosed in EP 0 971 023 A1 in [0063] to [0065]; polyalkyleneamines, polyalkyleneimine or the like polymers as disclosed in EP 0 971 023 A1 in [0066] to [0073] and [0085] to [0091]; diallylamine polymers as disclosed in EP 0 971 023 A1 in [0074] to [0076] and [0092] to [0095]; and combinations thereof.

The Binder

The detergent component of the present invention may also be incorporated into a binder, typically at a level of from 0.1% to 100%, preferably from 10% to 90%, more preferably from 40% to 85% by weight of the binder. Said binder may form part of a powder detergent composition, or can be integrated to the particles forming the tablet detergent composition, typically at a level of from 0.5% to 50%, preferably of from 1% to 20%, more preferably of from 2% to 8%, and most preferably of from 2.5% to 5% by weight of detergent composition.

This detergent composition may comprise one or more of the following materials: the surfactant agglomerate of the present invention; surfactants, e.g. nonionic, anionic, cationic, amphoteric and zwitterionic surfactants, all of them disclosed for example in WO 98/44084 on Pages 8 to 16; builders as disclosed in WO 98/44084 on Pages 16 to 18; hydrotropes and dissolution aids as disclosed in WO 98/44084 on Pages 8 to 9 and in WO 02/31100 on Pages 6 to 9, respectively; perfumes; fabric softening agents as disclosed in WO 96/11248 on Pages 4 to 7; enzymes and enzyme stabilizers as discloses in WO 98/44084 on Pages 27 to 29; optical brighteners as discloses in WO 98/44084 on Page 36; a bleaching system as discloses in WO 98/044084 on Pages 19 to 26; chelating agents as discloses in WO 98/44084 on Pages 26 to 27; suds suppressors as discloses in WO 98/44084 on Pages 31 to 32; wrinkle reducing agents; fabric abrasion reducing polymers; chlorine scavengers as disclosed in WO 96/11248 on Pages 7 to 9; pH-modifier as disclosed in WO 96/11248 on Pages 14 to 15; dye fixing agents; polymeric dye transfer inhibiting agents as disclosed in WO 98/44084 on Pages 33 to 35; soil release agents and soil suspensing polymers as disclosed in WO 98/44084 on Pages 29 to 30; clay softening system as discloses in WO 98/44084 on Pages 32 to 33; colourants; lime soap dispersants; and compatible combinations thereof. These materials can optionally also be part of the detergent component of the present invention.

In a preferred embodiment of the present invention, the powder detergent composition is compressed to form a tablet detergent composition as described in detail below.

Process of Making the Detergent Component, the Surfactant Agglomerate and the Tablet Detergent Composition of the Present Invention

The detergent component and the surfactant agglomerate of the present invention can be produced by any process wherein the polyether and the hard Lewis acid, and optionally further ingredients, are combined to form a mixture. When looking at the detergent component of the present invention, the mixture may be in any form, such as a liquid (especially at elevated temperatures), a slurry (especially at medium temperatures), or a solid material, such as a granule, or a particulate. The term “liquid” includes any liquid form such as a gel, a viscous liquid, etc. When looking at the surfactant agglomerate of the present invention, the mixture is in solid form, such as a granule, or a particulate. The mixture may be formed into particulate materials, such as granules by, for example, an extrusion process, a fluid bed process, rotary atomization, agglomeration or a moulding process. Preferably, the granules are formed by an agglomeration and/or an extrusion process. The agglomeration and also the extrusion process provide a simple, fast, efficient, cost-effective means of preparing a granule.

In another preferred embodiment, especially when the detergent component of the present invention is a binder, or forms part of a binder system, the detergent component is applied in liquid form, e.g., by keeping the temperature by a heating means, above the solidification point of such detergent component. Such a liquid detergent component can then be incorporated either into a detergent composition, or can be combined with a carrier to form the surfactant agglomerate of the present invention, or, can form a binder system, optionally with other materials, and can be subsequently combined with a particulate material comprising a detergent composition to form the powder or the tablet detergent composition of the present invention. The binder and the particulate material are typically combined by a spray-on process, which requires the binder to be present in liquid form. Generally, the detergent component is prepared and stored in liquid form before sprayed onto particulate materials to bind those particulate materials together. Such particulate materials may be used as such to form the powder detergent composition, and/or may be compressed to form a tablet as explained herein below. However, it is also possible to solidify the detergent component prior to using it as a binder or as part of a binder system and to bring it into liquid form, by a heating means for example, prior to spray the detergent component onto the particulate material which may form in the end the tablet detergent composition.

For the preparation of the mixture, any type of mixer may be used, especially a dynamic mixer. The mixing equipment will need to be selected to handle the viscosities that the mixture will reach. The exact viscosity will depend on the composition of the mixture and on the processing temperature. Preferably the processing temperature is below 120° C., preferably below 100° C., more preferably below 80° C., and most preferably between 40° C. and 75° C.

The mixture may be subsequently granulated by various process means. Preferred means are described in more detail below:

Fine Mixing and Granulation

Suitable pieces of equipment in which to carry out the fine mixing or agglomeration of the present invention are mixers of the Fukae® FS-G Series manufactured by Fukae Powtech Kogyo Co. Japan. This apparatus is essentially in the form of a bowl-shaped vessel accessible via a top port, provided near its base with a stirrer having substantially vertical axis, and a cutter positioned on a side wall. The stirrer and cutter may be operated independently of one another and at separately variable speeds. The vessel can be fitted with a heating or cooling jacket.

Other similar mixers found to be suitable for use in the process of the invention include Diosna® V series ex Dierks & Söhne, Germany; and the Pharma Matrix® ex T K Fielder Ltd., England. Other mixers believed to be suitable for use in the process of the invention are the Fuji® VG-C series ex Fuji Sangyo Co., Japan; and the Roto® ex Zanchetta & Co srl, Italy.

Other preferred suitable equipment can include Eirich® Series R and RV, manufactured by Gustau Eirich Hardheim, Germany; Lödige, Series FM for batch mixing or series CB and KM, either separately or in series for continues mixing/agglomeration, manufactured by Lödige Maschinenbau GmbH, Paderborn Germany; Drais® T 160 Series, manufactured by Drais Werke GmbH, Mannheim, Germany; and Winkworth® RT 25 series, manufactured by Winkworth Manchinery Ltd., Berkshire, England.

The Littleford Mixer, Model #FM-130-D-12, with internal chopping blades and the Cuisinart Food Processor, Model #DCX-Plus, with 7.75 inch (19.7 cm) blades are two more examples of suitable mixers. Any other mixer with fine mixing and granulation capability and having a residence time in the order of 0.1 to 10 minutes can be used. The “turbine-type” impeller mixer, having several blades on an axis of rotation, is preferred. The invention can be practiced as a batch or a continuous process.

The following exemplifies the mixing and agglomeration process by which the detergent component and the surfactant agglomerate of the present invention can be produced.

The polyether and the Lewis acid are mixed together in a colloid mill. When further adding optional adjunct materials are, added, the mixture can be transferred to a high shear mixer agglomerator (Eirich R-Series), at 1000 rpm to 3000 rpm in order to mix the components intimately. Granules are progressively formed. The mixing of the components is stopped when course granules are formed.

Further Processing Steps

The detergent components and the surfactant agglomerate obtained by the processes above are suitable for direct use, or may be treated by additional process steps such as the commonly used steps of heating, drying, cooling, and/or dusting the detergent component and the surfactant agglomerate. In addition, the detergent components and the surfactant agglomerates of the present invention may be blended with other components. The detergent components and the surfactant agglomerates can be screened through different sieves.

The weight mean particle size of the detergent components and the surfactant agglomerates of the present invention will generally be from 200 μm to 2000 μm, preferably being at least 300 μm and not above 1700 μm, preferably below 1600 μm. This weight mean particle size can for example be determined by sieve analysis, for example by sieving a sample of the particulate relevant material herein through a series of sieves, typically 5, with meshes of various diameter or aperture size, obtaining a number of fraction (thus having a particle size of above, below or between the mesh size of the used sieve size).

Preferably at least 70% or even at least 80% by weight of said detergent component and said surfactant agglomerate have a particle size from 200 μm to 2000 μm, more preferably from 300 μm to 1700 μm, and most preferably from 380 μm to a 1550 μm.

The density of the detergent component and the surfactant agglomerate of the present invention will generally be above 300 kg/m³, preferably greater than 400 kg/m³ or even greater than 500 kg/m³ and generally be below 1200 kg/m³, preferably below 1000 kg/m³.

The surfactant agglomerate, the powder detergent composition and the tablet detergent composition can be used in a conventional laundry machine.

For convenience reasons consumers prefer detergent compositions in form of a tablet. These tablets are more easily to dose, to handle, to transport and to store. Those tablets are dosed to the laundry machine via the dispensing drawer or they are dosed directly into the drum. When the compositions of the present invention are tablets, they can be prepared simply by mixing the solid ingredients together and compressing the mixture in a conventional tablet press as used, for example, in the pharmaceutical industry, in the food industry, or in the detergent industry. The detergent tablets can be made in any size or shape and can, if desired, be coated. The particulate materials (other than the agglomerates of the invention) used for making the tablet can be made by any particulation or granulation process. An example of such a process is spray drying (in a co-current or counter current spray drying tower) which typically gives low bulk densities 600 kg/m³ or lower. Particulate materials of higher density can be prepared by granulation and densification in a high shear batch mixer/granulator or by a continuous granulation and densification process (e.g. using Lödige TM CB and/or Lödige TM KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). The detergent component of the present invention in form of a binder; or any other binder, preferably a non-gelling binder; can be sprayed on to the mix of some, or, on the mix of all of the particulate materials, either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy TM, Korch TM, Manesty TM, or Bonals TM). Tablets prepared should preferably have a diameter of between 40 mm and 60 mm, and a weight between 25 and 100 g. The ratio of height to diameter (or width) of the tablets is preferably greater than 1:3, more preferably greater than 1:2. The compaction pressure used for preparing these tablets need not exceed 5000 kN/m, preferably not exceed 3000 kN/m, and most preferably not exceed 1000 kN/m.

The detergent component of the present invention in form of a binder; or any other binder preferably a non-gelling binder; are preferably sprayed on and hence have an appropriate melting point temperature below 70° C. and preferably below 50° C. so as not to damage or degrade the other active ingredients in the matrix. Most preferred are non-aqueous liquid binders (i.e. not in aqueous solution) which may be sprayed in molten form. However, they may also be solid binders incorporated into the matrix by dry addition but which have binding properties within the tablet.

The binders are preferably used in an amount within the range from 0.1 to 15% of the composition, more preferably below 5% and especially if it is a non laundry active material below 2% by weight of the tablet.

The tablets may be coated so that the tablet does not absorb moisture, or absorbs moisture at only a very slow rate. The coating is also strong so that moderate mechanical shocks to which the tablets are subjected during handling, packing and shipping result in no more than very low levels of breakage or attrition. Finally the coating is preferably brittle so that the tablet breaks up when subjected to stronger mechanical shock. Furthermore it is advantageous if the coating material is dissolved under alkaline conditions, or is readily emulsified by surfactants. This contributes to avoiding the problem of visible residue in the window of a front-loading washing machine during the wash cycle, and also avoids deposition of undissolved particles or lumps of coating material on the laundry load.

Water solubility is measured following the test protocol of ASTM E1148-87 entitled, “Standard Test Method for Measurements of Aqueous Solubility”.

Suitable coating materials are dicarboxylic acids. Particularly suitable dicarboxylic acids are selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof.

The coating material has a melting point preferably of from 40° C. to 200° C. The coating can be applied in a number of ways. Two preferred coating methods are a) coating with a molten material and b) coating with a solution of the material. In a), the coating material is applied at a temperature above its melting point, and solidifies on the tablet. In b), the coating is applied as a solution, the solvent being dried to leave a coherent coating. The substantially insoluble material can be applied to the tablet by, for example, spraying or dipping. Normally when the molten material is sprayed on to the tablet, it will rapidly solidify to form a coherent coating. When tablets are dipped into the molten material and then removed, the rapid cooling again causes rapid solidification of the coating material. Clearly substantially insoluble materials having a melting point below 40° C. are not sufficiently solid at ambient temperatures and it has been found that materials having a melting point above 200° C. are not practicable to use. Preferably, the materials melt in the range from 60° C. to 160° C., more preferably from 70° C. to 120° C.

A coating of any desired thickness can be applied according to the present invention. For most purposes, the coating forms from 1% to 10%, preferably from 1.5% to 5%, of the tablet weight.

Such tablet coatings are very hard and provide extra strength to the tablet.

In a preferred embodiment the fracture of the coating in the wash is improved by adding a disintegrant in the coating. This disintegrant will swell once in contact with water and break the coating in small pieces. This will improve the dissolution of the coating in the wash solution. The disintegrant is suspended in the coating melt at a level of up to 30%, preferably between 5% and 20%, most preferably between 5 and 10% by weight. Possible disintegrants are described in Handbook of Pharmaceutical Excipients (1986). Examples of suitable disintegrants include starch: natural, modified or pregelatinized starch, sodium starch gluconate; gum: agar gum, guar gum, locust bean gum, karaya gum, pectin gum, tragacanth gum; croscarmylose Sodium, crospovidone, cellulose, carboxymethyl cellulose, algenic acid and its salts including sodium alginate, silicone dioxide, clay, polyvinylpyrrolidone, soy polysacharides, ion exchange resins and mixtures thereof.

Depending on the composition of the starting material, and the shape of the tablets, the used compaction force will be adjusted to not affect the strength (Diametral Fracture Stress), and the disintegration time in the washing machine. This process may be used to prepare homogenous or layered tablets of any size or shape.

In another preferred embodiment of the present invention the tablets further comprises an effervescent. Effervescency as defined herein means the evolution of bubbles of gas from a liquid, as the result of a chemical reaction between a soluble acid source and an alkali metal carbonate, to produce carbon dioxide gas,
i.e. C6H8O7+3NaHCO3->Na3C₆H5O7+3CO2 &uarr&+3H2O

Tablets can also be used in a method of washing which comprises the preparation of an aqueous solution of a laundry detergent for use in a front-loading washing machine, the front-loading washing machine having a dispensing drawer and a washing drum, wherein the aqueous solution of laundry detergent is formed by the tablet which is placed in the dispensing drawer before water is passed through the dispensing drawer so that the tablet is dispensed as an aqueous solution of a laundry detergent, the aqueous solution subsequently being passed in the washing drum.

Processes for preparing detergent tablets by compressing a granule to form a tablet have been intensively described in the prior art, i.e., GB 2 327 947 (P&G); WO 00/50559 (Henkel); EP 0 711 828 (Unilever); WO 01/48131 (Cognis); EP 0 971 028 and EP 0 971 029 (P&G); WO 98/42817 (Unilever); EP 0 598 586 (Unilever).

The detergent component of the present invention, the surfactant agglomerate, the powder detergent composition and the tablet detergent composition comprising said detergent component of the present invention, are generally substantially non-aqueous (or anhydrous) in character. While very small amounts of water may be incorporated into such detergent component, in the surfactant agglomerate, in the powder detergent composition and in the tablet detergent composition as an impurity in the raw materials, the amount of water should preferably not exceed 9% by weight of the detergent component or of the surfactant agglomerate, or of the powder detergent composition, or of the tablet detergent composition, respectively. Preferably, the water-content is less than 7% by weight of the detergent component or of the surfactant agglomerate, or of the powder detergent composition, or of the tablet detergent composition, respectively; more preferably less than 5% by weight of the detergent component or of the surfactant agglomerate, or of the powder detergent composition, or of the tablet detergent composition, respectively; and even most preferably less than 3% by weight of the detergent component or of the surfactant agglomerate, or of the powder detergent composition, or of the tablet detergent composition, respectively.

### EXAMPLES

### Example I

### Binders

A high shear mixer/agglomerator (Lodige FM 130) is loaded with 97 g of Polyethylene glycol 200 and heated up to 70° C. 3 g of boric acid are added under stirring. The resulting mixture is stirred for another 45 minutes to ensure close proximity of the Lewis acid and the PEG 200.

The resulting mixture kept at evaluated temperatures above the solidification point, can be directly applied as a spray-on binder on a powder detergent composition to be then used as such or as a basis to form a tablet detergent composition. It is also possible to allow solidification of the resulting mixture, and to melt it before using it as a spray-on binder on either a powder detergent composition or on a tablet detergent composition.

Compositions 2 to 12 are prepared in a similar manner.

| | 1 | 2 | 3 | 4 | 5 | 6 |
|---|---|---|---|---|---|---|
| Polyethyleneglycol | 97 | 94 | 88 | 90 | 87 | 85 |
| 200 | | | | | | |
| Boric acid | 3 | 6 | 12 | — | — | 7 |
| Li₂SO₄ | — | — | — | 10 | 13 | 8 |
| | 7 | 8 | 9 | 10 | 11 | 12 |
| Polyethyleneglycol | 97 | 94 | 88 | 85 | 90 | 88 |
| 4000 | | | | | | |
| Polyethyleneglycol | — | — | — | 5 | — | 3 |
| 200 | | | | | | |
| Boric acid | 3 | 6 | 12 | 10 | 6 | 4 |
| Al₂(SO₄)₃ | — | — | — | — | 4 | 5 |

The above binders demonstrate increased viscosity.

### Example II

### Surfactant Agglomerate

A high shear mixer/agglomerator (Lodige FM 130) is loaded with 35 g of Neodol 45-AE 7 and heated up to 80° C. 6.0 g of boric acid are added under stirring. The resulting mixture is stirred for another 45 minutes to ensure close proximity of the Lewis acid and the nonionic surfactant. 36 g of sodium acetate, 10 g of Zeolithe A and 10 g of sodium bicarbonate are added to allow agglomeration.

Compositions 2 to 10 are prepared in a similar manner.

| | % by weight of the granule | | | | |
|---|---|---|---|---|---|
| | 1 | 2 | 3 | 4 | 5 |
| Nonionic surfactant (1) | 35 | 30 | 35 | 35 | 35 |
| Sodium acetate | 36 | 30 | 36 | 24 | 24 |
| Ethoxylated quaternized | — | 6.0 | — | 6.0 | 6.0 |
| hexylene diamine | | | | | |
| Boric acid | 6.0 | 6.0 | 6.0 | 12 | 12 |
| Zeolithe A | 10 | 10 | — | 20 | — |
| Sodium bicarbonate | 10 | 15 | 20 | — | 20 |
| Adjuncts | 3.0 | 3.0 | 3.0 | 3.0 | 3.0 |

(1): Blend of C₁₄, and C₁₅ alcohols ethoxylated with 7 eq. moles of ethylene oxide on average (Neodol ® 45-AE 7) ex Shell.

Surfactant agglomerates 1 to 5 contain high levels of nonionic surfactants.

| | % by weight of the granule | | | | |
|---|---|---|---|---|---|
| | 6 | 7 | 8 | 9 | 10 |
| Nonionic surfactant (1) | 25 | 25 | 25 | 25 | 25 |
| Sodium acetate | 6.0 | — | 18 | 30 | 6.0 |
| Ethoxylated quaternized | 6.0 | 6.0 | 6.0 | — | 6.0 |
| hexylene diamine | | | | | |
| Boric acid | 12 | 12 | — | — | 2.0 |
| Lithium Chloride | — | — | 5.0 | — | 5.0 |
| Aluminium Sulphate | — | — | — | 5.0 | — |
| Zeolithe A | 28 | 34 | 23 | 17 | 33 |
| Sodium bicarbonate | 20 | 20 | 20 | 20 | 20 |
| Adjuncts | 3.0 | 3.0 | 3.0 | 3.0 | 3.0 |

(1): Blend of C₁₄, and C₁₅ alcohols ethoxylated with 7 eq. moles of ethylene oxide on average (Neodol ® 45-AE 7) ex Shell.

Surfactant agglomerates 6 to 10 contain a constant level of nonionic surfactants, and offer additional room in the formulation card for other beneficial components such as Zeolithe A, acetate, and combinations thereof.

### Example IV

### Tablet Detergent Composition

A detergent base powder of a finished laundry detergent was put together by blending the following components shown in the table below, except for the components which were sprayed on. The tablet was made the following way: 55 g of the mixture was introduced into a mould of circular shape with a diameter of 55 mm and compressed to give a tablet of 2 cm height. The tensile strength (or diametrical fracture stress) of the tablet was 9 kPa.

| Ingredient | % by weight of the composition | | |
|---|---|---|---|
| Anionic agglomerates 1 (1) | 10.0 | 23.0 | 13.0 |
| Anionic agglomerates 2 (2) | — | 22.0 | 12.25 |
| Surfactant agglomerate 2 (see | 35.0 | — | 25.0 |
| above, Example II, entry 3) | | | |
| Cationic agglomerates (3) | 5.0 | 13.6 | 8.1 |
| Layered silicate (4) | 10.0 | 8.0 | 8.0 |
| Sodium percarbonate | 12.0 | 10.0 | 10.0 |
| Bleach activator agglomerates (5) | 6.0 | 5.0 | 5.0 |
| Sodium carbonate | 7.0 | 6.0 | 6.0 |
| EDDS/Sulphate particle (6) | 0.5 | 0.4 | 0.4 |
| Tetrasodium salt of Hydroxyethane | 0.6 | 0.3 | 0.3 |
| Diphosphonic acid | | | |
| Soil release polymer | 0.3 | 0.5 | 0.5 |
| Optical brightener | 0.2 | 0.3 | 0.3 |
| Zinc Phthalocyanine sulphonate | 0.1 | 0.2 | 0.2 |
| encapsulate (7) | | | |
| Soap powder | 1.3 | 2.0 | 2.0 |
| Suds suppresser (8) | 1.5 | 2.0 | 2.0 |
| Citric acid | 4.5 | 3.0 | 3.0 |
| Enzyme | 3.0 | 2.2 | 2.2 |
| Binder spray on system (9) | 3.0 | — | — |
| Binder spray on system (see above, | — | 1.5 | 1.75 |
| Example I, entry 2) | | | |
| | 100.0 | 100.0 | 100.0 |

(1) Anionic agglomerates 1 comprise of 40% anionic surfactant, 27% zeolite and 33% carbonate; mean particle size: 630 μm; density: 620 kg/m³.
(2) Anionic agglomerates 2 comprise of 40% anionic surfactant, 28% zeolite and 32% carbonate; mean particle size: 635 μm; density: 615 kg/m³.
(3) Cationic agglomerate comprise of 20% cationic surfactant, 56% zeolite and 24% sulfate.
(4) Layered silicate comprises of 95% SKS 6 and 5% silicate; mean particle size: 469 μm; density: 901 kg/m³.
(5) Bleach activator agglomerates comprise of 81% Tetraacetylethylene diamine (TAED), 17% acrylic/maleic copolymer (acid form) and 2% water; mean particle size: 514 μm; density: 688 kg/m³.
(6) EDDS/Sulphate particle particle comprise of 58% of Ethylene diamine-N,N-disuccinic acid sodium salt, 23% of sulphate and 19% water.
(7) Zinc phthalocyanine sulphonate encapsulates are 10% active.
(8) Suds suppresser comprises of 11.5% silicone oil (ex Dow Corning), 59% zeolite and 29.5% water
(9) Binder spray on system comprises of 0.5 parts of Lutensit K-HD 96 and 2.5 parts of Polyethylene glycols (PEG).

1. A detergent component to be used in a solid detergent composition, comprising:
(a) a substituted or unsubstituted polyether; and
(b) a metal or half-metal, hard Lewis-acid having an effective ion radius of less than 100 pm.

2. The detergent component according to claim 1 wherein the Lewis acid is selected from the group consisting of: Al³⁺, B³⁺, Be²⁺, Co²⁺, Cu²⁺, Fe³⁺, Ga³⁺, Ge²⁺, Ge⁴⁺, In³⁺, Li⁺, Mg²⁺, Mn²+, Mn⁷⁺, Mo⁶⁺, Sc³⁺, Si⁴⁺, Sn⁴⁺, Ti⁴⁺, Zn²⁺, Zr⁴⁺, and combinations thereof.

3. The detergent component according to claim 2 wherein the Lewis acid is selected from 0 the group consisting of: Al³⁺, B³⁺, Co²⁺, Cu²⁺, Fe³⁺, Ga³⁺, Ge⁴⁺, Li⁺, Mg²⁺, Si⁴⁺, Sn⁴⁺, Ti⁴⁺, Zn²⁺, Zr⁴⁺, and combinations thereof.

4. The detergent component according to claim 3 wherein the Lewis acid is selected from the group consisting of: Al³⁺, B³⁺, Ge⁴⁺, Si⁴⁺, and combinations thereof.

5. The detergent component according to claim 1 wherein the Lewis-acid has an effective ion radius of less than 75 pm.

6. The detergent component according to claim 5 wherein the Lewis-acid has an effective ion radius of less than 55 pm.

7. The detergent component according to claim 1 wherein the Lewis-acid is selected from the group consisting of: Al₂(SO₄)₃, Al(SO₄R)₃, AlPO₄, Al₂(HPO₄)₃, Al(H₂PO₄)₃, Al(OH)₃, Al(OC[O]R)₃; B₂(SO₄)₃, B(SO₄R)₃, B₂(HPO₄)₃, B(H₂PO₄)₃, B(OH)₃, B(OH)X(OR)₃₋ₓ, B(OC[O]R)₃; and combinations thereof, wherein R is selected from the group consisting of C₁ to C₁₅ unsubstituted and substituted, linear, branched or cyclic alkyl, and arylalkyl, and combinations thereof; and wherein x is an integer from 1 to 3.

8. The detergent component according to claim 1 wherein the polyether is present at levels from 1% to 99% by weight of the detergent component.

9. The detergent component according to claim 8 wherein the polyether is present at levels from 30% to 80% by weight of the detergent component.

10. The detergent component according to claim 1 wherein the Lewis-acid is present at levels from 1% to 50% by weight of the detergent component.

11. The detergent component according to claim 10 wherein the Lewis-acid is present at levels from 2.5% to 5.0% by weight of the detergent component.

12. The detergent component according to claim 1 wherein the polyether comprises groups selected from the group consisting of: ethoxy-(—CH₂CH₂O—) groups, n-propoxy-(—CH₂CH₂CH₂O—) groups, iso-propoxy-(—CH₂CH(CH₃)O—) groups, n-butoxy-(—CH₂CH₂CH₂CH₂O—) groups, iso-butoxy-(—CH₂CH(CH₃)CH₂O—) groups, tert-butoxy-(—CH₂C(CH₃)₂O—) groups, and combinations thereof.

13. The detergent component according to claim 1 wherein the polyether has an alkoxylation degree from 2 to 500.

14. The detergent component according to claim 13 wherein the polyether has an alkoxylation degree from 5 to 15.

15. A process for the preparation of a detergent component according to claim 1 comprising the step of combining a substituted or unsubstituted polyether with a metal or half-metal, hard Lewis-acid having an effective radius of less than 100 pm.

16. A surfactant agglomerate comprising
(a) a carrier, and
(b) the detergent component according to claim 1.

17. A process for making of the surfactant agglomerate according to claim 16 wherein the detergent component is agglomerated with a carrier.

18. A powder detergent composition comprising surfactant agglomerates according to claim 16 and other detergency ingredients.

19. A powder detergent composition comprising the detergent component according to claim 1 and other detergency ingredients.

20. The powder detergent composition according to claim 19 wherein the detergent component is sprayed-on.

21. A tablet detergent composition formed by compressing the powder detergent composition of claim 18.

22. A tablet detergent composition formed by compressing the powder detergent composition of claim 19.

23. A tablet detergent composition formed by compressing the powder detergent composition of claim 20.

24. A process for making a powder detergent composition comprising the step of combining a binder with a particulate material comprising other detergency ingredients wherein the binder comprises the detergent component according to claim 1.

25. A process for preparing a detergent tablet composition comprising the step of contacting a binder to a powder detergent wherein the binder comprises the detergent component according to claim 1.

26. The process according to claim 24 wherein the binder is present in liquid form.

27. The process according to claim 26 wherein the binder is sprayed on.

28. The process according to claim 25 wherein the binder is present in liquid form.

29. The process according to claim 28 wherein the binder is sprayed on.

30. The use of a metal, or half-metal, hard Lewis-acids having an effective ion radius of less than 100 pm, for increasing the viscosity and/or the melting point of a substituted or unsubstituted polyether.

31. A powder detergent composition comprising
I. surfactant agglomerates comprising
(a) a carrier, and
(b) a detergent component wherein the detergent component comprises:
i. from 30% to 80% by weight of the detergent component, of a substituted or unsubstituted polyether, comprising groups selected from the group consisting of: ethoxy-(—CH₂CH₂O—) groups, n-propoxy-(—CH₂CH₂CH₂O—) groups, iso-propoxy-(—CH₂CH(CH₃)O—) groups; and any combination thereof;
ii. from 1.0% to 50% by weight of the detergent component, of a metal or half-metal, hard Lewis-acid selected from the group consisting of: Al₂(SO₄)₃, Al(SO₄R)₃, AlPO₄, Al₂(HPO₄)₃, Al(H₂PO₄)₃, Al(OH)₃, Al(OC[O]R)₃; B₂(SO₄)₃, B(SO₄R)₃, B₂(HPO₄)₃, B(H₂PO₄)₃, B(OH)₃, B(OH)X(OR)₃₋ₓ, B(OC[O]R)₃; and combinations thereof, wherein R is selected from the group consisting of C₁ to C₁₅ unsubstituted and substituted, linear, branched or cyclic alkyl, and arylalkyl, and combinations thereof; and wherein x is an integer from 1 to 3; and
II. other detergency ingredients.

32. A powder detergent composition comprising
1. a detergent component wherein the detergent component comprises:
(a) from 30% to 80% by weight of the detergent component, of a substituted or unsubstituted polyether, comprising groups selected from the group consisting of: ethoxy-(—CH₂CH₂O—) groups, n-propoxy-(—CH₂CH₂CH₂O—) groups, iso-propoxy-(—CH₂CH(CH₃)O—) groups; and any combination thereof,
(b) from 1.0% to 50% by weight of the detergent component, of a metal or half-metal, hard Lewis-acid selected from the group consisting of: Al₂(SO₄)₃, Al(SO₄R)₃, AlPO₄, Al₂(HPO₄)₃, Al(H₂PO₄)₃, Al(OH)₃, Al(OC[O]R)₃; B₂(SO₄)₃, B(SO₄R)₃, B₂(HPO₄)₃, B(H₂PO₄)₃, B(OH)₃, B(OH)ₓ(OR)₃₋ₓ, B(OC[O]R)₃; and combinations thereof, wherein R is selected from the group consisting of C₁ to C₁₅ unsubstituted and substituted, linear, branched or cyclic alkyl, and arylalkyl, and combinations thereof; and wherein x is an integer from 1 to 3; and
II. other detergency ingredients.

33. A tablet detergent composition formed by compressing the powder detergent composition of claim 31.

34. A tablet detergent composition formed by compressing the powder detergent composition of claim 32.
